(19) United States
(12) Patent Application Publication
(10) Pub. No.: US 2025/0091081 A1
(43) Pub. Date: Mar. 20, 2025

(54) SPRINKLER STRIP AND SPRINKLER IRRIGATION STAND

(71) Applicant: NETAFIM, LTD., TEL AVIV (IL)

(72) Inventors: EREZ GOVRIN, KIBBUTZ MAGAL (IL); TAMIR ITAI, KIBBUTZ MAAGAN MICHAEL (IL)

(73) Assignee: NETAFIM, LTD., TEL AVIV (IL)

(21) Appl. No.: 18/953,315

(22) Filed: Nov. 20, 2024

Related U.S. Application Data
(63) Continuation-in-part of application No. PCT/IB2023/055465, filed on May 28, 2023.
(60) Provisional application No. 63/346,872, filed on May 29, 2022.

(51) Int. Cl. B05B 15/658; A01G 25/09

(52) U.S. Cl. CPC B05B 15/658; A01G 25/095

(57) ABSTRACT

A sprinkler irrigation stand includes a base and a clamp. The clamp is pivotally coupled at a first end to a first lateral side of the base and has a non-deployed state and a deployed state. In the non-deployed state, the clamp is not attached at its other second end to the base and in the deployed state the clamp is attached at its other second end to a second opposing lateral side of the base. The base also includes a depression that extends along a longitudinal extension of the base that is orthogonal to its lateral extension.

### RELATED APPLICATIONS

This is Bypass Continuation-in-Part of PCT/IB2023/055465 filed 28 May 2023 and published as WO 2023/233260A1. Priority is claimed to U.S. Provisional Patent Application No. 63/346,872 filed 29 May 2022. The contents of the aforementioned applications are incorporated by reference in their entirety.

### TECHNICAL FIELD

Embodiments of the present invention relate to a sprinkler strip and to a sprinkler irrigation stand thereof, and in particular to retrievable sprinkler strips.

### BACKGROUND

U.S. Pat. No. 3,843,059 describes a device for attaching risers to an irrigation pipe. The device has complimentary clamp parts that are adapted to tightly clamp therebetween an irrigation pipe, and a riser that is attached to one of the clamp parts is adapted to support a sprinkler.

U.S. Pat. No. 5,452,872 describes a stabilizer for portable irrigation equipment. The irrigation equipment includes a plurality of extension pipes interconnected by couplings and extending up from each coupling is a riser at the top of which is a sprinkler. A stabilizer placed on the ground adjacent the riser is adapted to lean against the riser to hold the riser and sprinkler head in their correct positions.

U.S. Pat. No. 4,275,839 describes stabilizer devices that are fixed to a hose at intervals. Each stabilizer has a base that is positioned on the ground and is provided with a recess for saddling the hose and a clamp member that is attached to a riser and is adapted to clamp the hose from above.

U.S. Pat. No. 8,646,734 describes a sprinkler irrigation stand for use with an irrigation pipe that has a base placed below the pipe for being stabilized by the pipe. The pipe freely rests upon the base so that it may be lifted freely off the base or may inflate freely upwards in the case the pipe is a collapsible pipe. A riser of the stand for supporting a sprinkler may be attached to the pipe and slide up in relation to the stand when attached to a collapsible pipe that is inflated.

The stages of deployment and retrieval of sprinkler stands in or from a field can be complex and labor intensive, and therefore there is a need to simplify these stages. To meet these targets, one may attempt to suitably design the sprinkler stands and sprinkler strips that includes such sprinkler stands.

### SUMMARY

The following embodiments and aspects thereof are described and illustrated in conjunction with systems, tools and methods which are meant to be exemplary and illustrative, not limiting in scope.

In an embodiment there is provided a sprinkler irrigation stand comprising a base and an clamp member (“clamp”), the clamp member being pivotally coupled at a first end thereof to a first lateral side of the base and having non-deployed and deployed states, in the non-deployed state the clamp member is not attached at its other second end to the base (or free from attachment to the base) and in the deployed state the clamp member is attached at its other second end to a second opposing lateral side of the base, wherein the base comprising a depression that extends along a longitudinal extension of the base that is orthogonal to its lateral extension.

In an embodiment there is provided a sprinkler strip assembly comprising an irrigation pipe and a plurality of sprinkler stands located along the pipe, the sprinkler stand comprising a base and a clamp member, the clamp member being pivotally coupled at a first end thereof to a first lateral side of the base and having non-deployed and deployed states, in the non-deployed state the clamp member is not attached at its other second end to the base (or free from connection to the base) and in the deployed state the clamp member is attached at its other second end to a second opposing lateral side of the base, wherein the base comprising a depression that extends along a longitudinal extension of the base that is orthogonal to its lateral extension, associating the irrigation pipe with each one of the sprinkler stands by placing a section of the pipe comprising an outlet upon the depression of the base of each given stand with an axial extension of the pipe (or pipe section) being generally aligned or extending alongside the longitudinal extension of the base, and then revolving the clamp member of each stand to its deployed state where it overlies the pipe and coupling a sprinkler to the outlet of the pipe at each stand through a passage formed in the clamp member.

Said coupling may be directly between an inlet of the sprinkler and the pipe outlet or via a riser that bridges between the sprinkler's inlet and the pipe's outlet. Possibly such riser can be free to slide up or down through the passage through the clamp member to compensate e.g., for inflation deflation of a collapsible to pipe to which the sprinkler may be coupled.

And in an embodiment there is also provided a method of retrieving sprinkler stands from a field comprising the steps of: providing a sprinkler strip assembly comprising an irrigation pipe and a similar amount of sprinkler stands and sprinkler heads located along the pipe, each sprinkler stand comprising a base and a clamp member and being associated with a section of the pipe that is placed on its base below the clamp member by coupling one of the sprinklers to an outlet of its pipe section through a passage formed in the clamp member, and applying a pulling force to an end of the pipe urging the pipe to move in a retrieval direction together with the sprinkler stands that remain attached to the pipe.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIGS. 1A and 1B schematically show a sprinkler strip with sprinkler stands in accordance with an embodiment of the present invention, in respective non-deployed and deployed states;

FIGS. 2A and 2B schematically show a sprinkler stand such as one of those seen in FIGS. 1A and 1B in respective non-deployed and deployed states;

FIG. 3 schematically shows a closer view of the sprinkler stand in the deployed state seen in FIG. 2B;

FIG. 4 schematically shows an exploded view of the sprinkler stand of FIG. 3;

FIG. 5 schematically shows a view of the sprinkler stand along its longitudinal extension, the clamp of the sprinkler stand being in the deployed position seen in FIG. 2B where it clamps an irrigation pipe extending along an axis of the irrigation strip;

FIGS. 6A and 6B schematically show another embodiment of a sprinkler stand in respective deployed and non-deployed states;

FIG. 7 schematically shows another embodiment of a sprinkler stand generally similar to that in FIGS. 6A and 6B being coupled to an irrigation pipe;

FIG. 8 schematically shows a cross sectional view of the sprinkler stand of FIG. 7A;

FIG. 9 schematically shows a possible tilted state that sprinkler stands in accordance with various embodiments of the present invention may assume during retrieval from a field;

FIGS. 10A to 10E schematically show various wheeled sprinkler stand embodiments in accordance with an aspect of the present invention; and

FIGS. 11A to 11C schematically show a possible way of attaching wheels to a sprinkler stand.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

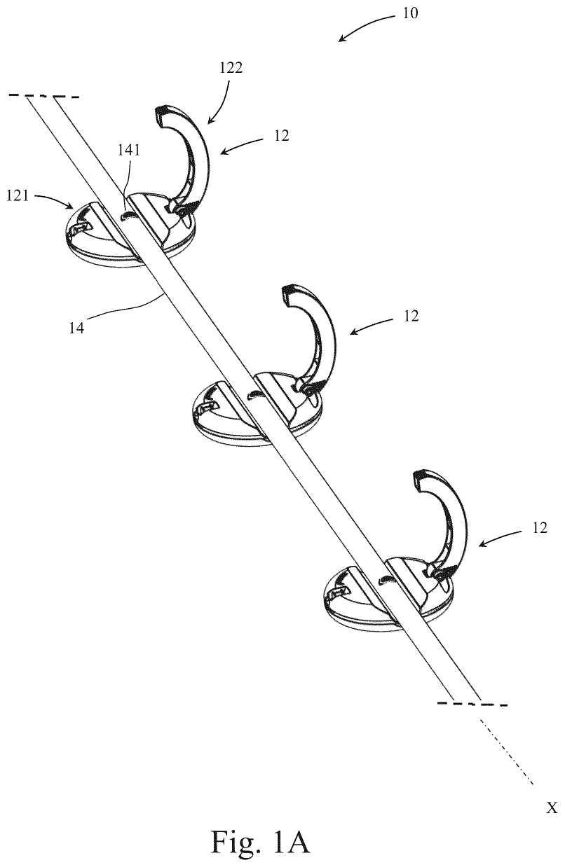

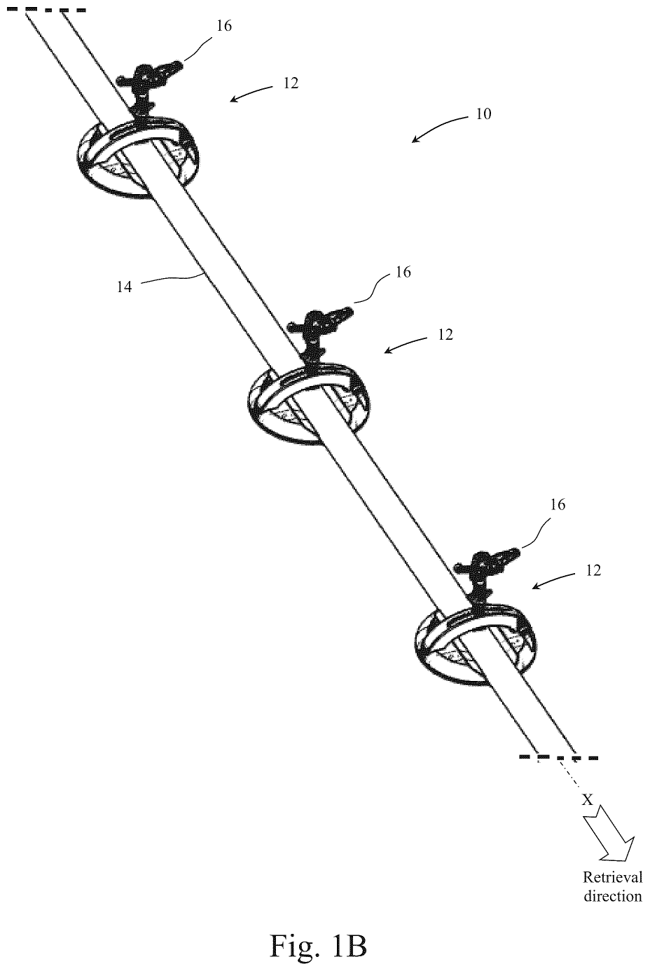

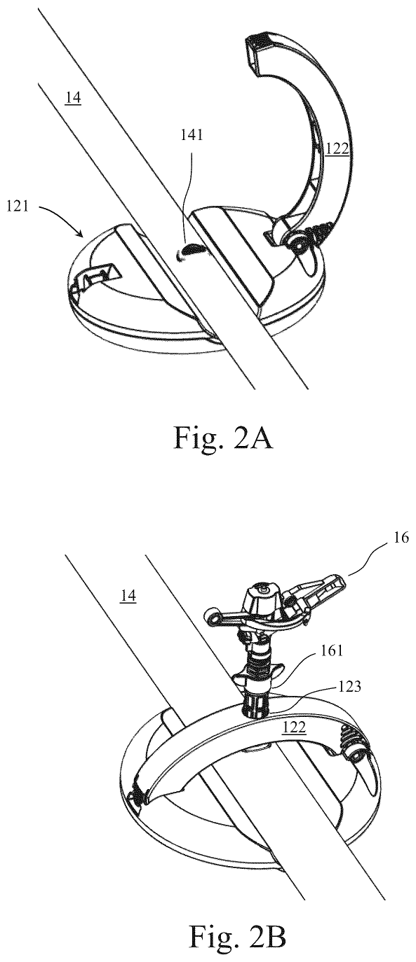

Attention is first drawn to FIGS. 1A, 1B, 2A and 2B schematically showing a sprinkler strip 10 in accordance with an embodiment of the present invention. The sprinkler strip 10 includes sprinkler stands 12 that are spaced apart along a longitudinal extension X of an irrigation pipe 14. In FIGS. 1A and 2A the sprinkler strip is seen in a non-deployed state and in FIGS. 1B and 2B in a deployed state.

A deployed state of a sprinkler strip may be accomplished by first locating an irrigation pipe in a field to be irrigated and then placing the irrigation pipe 14 upon a base 121 of each one of a group of stands that are spaced apart in the field. Then a clamp member 122 of each one of the stands can be revolved from an open position (see, e.g., FIG. 2A) towards a closed position (see, e.g., FIG. 2B) where it engages the base 121 forming a bridge or cover above the pipe 14 and/or base 121.

In the examples seen in FIGS. 1 to 5, the various disclosed sprinkler stands are designed each to include a clamp member having a relative narrow arm-like formation, in the sense that such an arm-like clamp member substantially only covers in its closed position a region of a pipe section that is laid on base 121, which includes an outlet 141.

A sprinkler 16 associated with each stand may then be inserted through a passage 123 (“clamp passage”) formed in the clamp member to be coupled with a respective one of the outlets 141 formed along the pipe's axial extension. Possibly, a riser 161 may be provided for each sprinkler, connected at one upper end to an inlet of the sprinkler and at its other lower end to an outlet in the pipe.

The sprinkler stand may be designed so that the riser and/or a lower portion of the sprinkler may be slidable through passage 123, for example to facilitate use of a collapsible irrigation pipe as the pipe supplying the liquid in the strip.

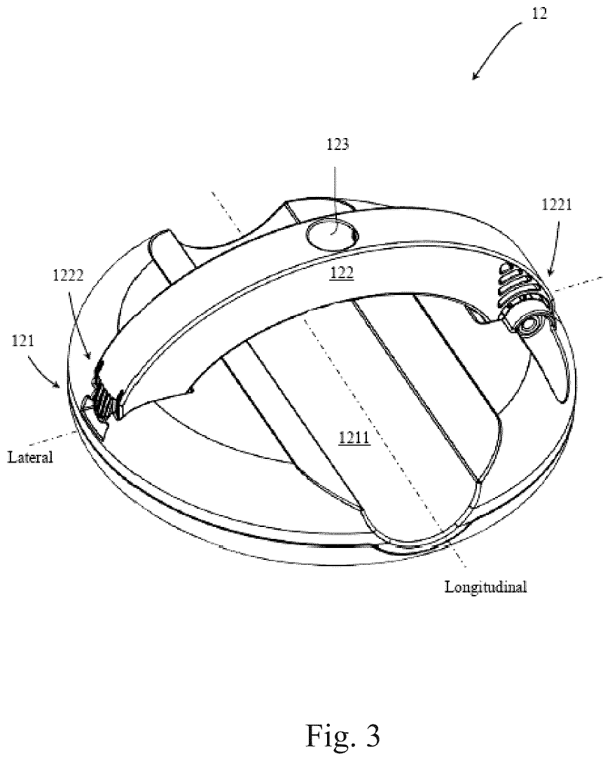

Attention is drawn to FIG. 3 for a closer view of an embodiment of a sprinkler stand 12. The sprinkler stand in this example has generally orthogonal longitudinal and lateral extensions, and the sprinkler stand's longitudinal extension is arranged to extend alongside, possibly generally coaxial, with a longitudinal extension X of an irrigation pipe that is mounted thereupon. The base 121 of the sprinkler stand as seen has a longitudinal extending depression 1211. Depression 1211 in this example lies on a generally cylindrical imaginary surface that has an axis, which extends in the longitudinal direction.

The clamp member 122 of the sprinkler stand 12 when in its closed position extends in the lateral direction. The clamp member has first and second mating regions 1221, 1222 with the base of the sprinkler stand. At the first mating region 1221 the clamp member may be pivotally coupled to a first lateral side of the base and at the second mating region 1222 the clamp member may be detachably attached, possibly in a snap fit arrangement, to a second opposing lateral side of the base.

Passage 123 may be formed generally midway between the clamp member's first and second mating regions and may be arranged to extend in an upright direction when the clamp member is in its closed position when it is attached, possibly in a snap fit arrangement, at its second mating region to the base. Thus, in the deployed position, the passage 123 directly overlies the depression 1211, and more particularly may overlie the deepest (central) part of the depression 1211.

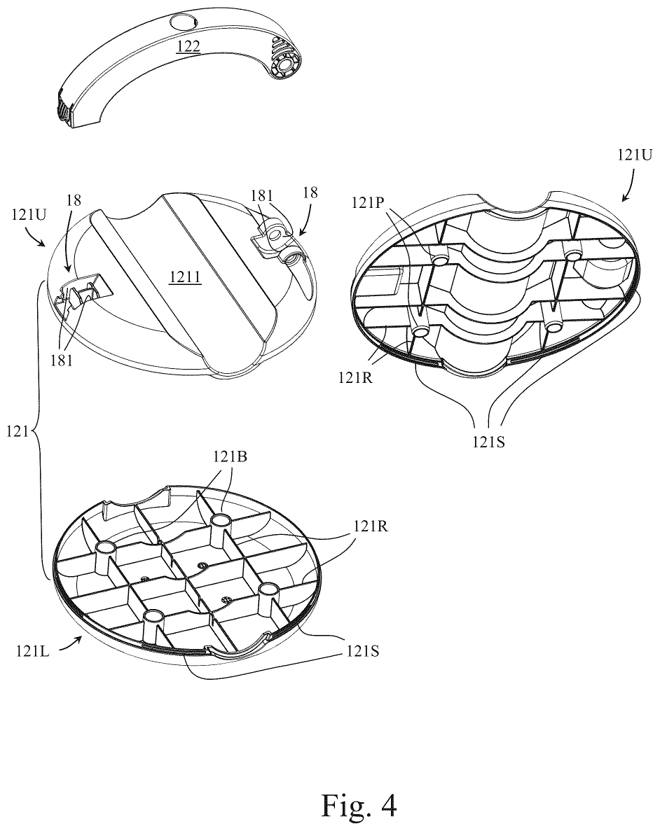

Attention is drawn to FIG. 4. In at least certain embodiments, base 121 may be formed as an outer shell formation enclosing a generally hollow interior. In an embodiment, such an outer shell formation may be formed by designing base 121 as having upper 121U and lower 121L shell members.

The upper and lower shell members 121U, 121L may be snap fitted one to the other via snap members 121S located on their peripheries. The upper and lower shell members 121U, 121L may also each include on their interior sides-groups of rib members 121R that extend along the longitudinal and lateral directions.

Such rib members may be aimed at strengthening the interior structure of the generally hollow base e.g., to provide support in the base below depression 1211 where the pipe is designed to be placed.

The interior sides of the upper and lower shell members 121U, 121L may include in addition respective pin members 121P and bore members 121B. In the assembled state of such as base, each pin member 121P here on the upper shell member's interior may be arranged to engage, possibly by entering into, a respective bore member 121B here on the lower shell member's interior.

Such interaction between pin and bore members may assist in withstanding forces, such as axial forces, that may be applied to the base when retrieving a sprinkler strip from a field.

In an aspect of the present invention, the sprinkler strip embodiments disclosed herein may be suited for being retrieved from a field where they are deployed by using the pipe to pull and retrieve the sprinkler stands.

With attention drawn back to FIG. 1B, such retrieval of a sprinkler strip can be seen being indicated by the arrow at the lower right-hand side of the figure. The retrieval may be performed by applying a pulling force at an axial end of the irrigation pipe and by that urging the sprinkler stands, that are fixed to the pipe via engagement with the sprinklers, to slide with their bases upon the ground face in the retrieval direction.

In certain embodiments, the irrigation pipe used in such a sprinkler strip may be as aforementioned of a collapsible type that may be deflated to be relatively lightweight when substantially no liquid is flowing therethrough and may swell up to an inflated weighted profile when full of liquid flowing therethrough.

In sprinkler strip embodiments that include a collapsible pipe, the applying of the pulling force to retrieve the sprinkler stands from the field may be accomplished by winding the irrigation pipe on a reel (or the like).

Possibly, prior to retrieving a sprinkler strip, liquid present within the pipe may be flushed out of the pipe so that the sprinkler strip may be easily retrieved and in the case of a collapsible pipe winding of the collapsible irrigation pipe on a reel may be performed. Flushing liquid from the pipe may be performed by opening a first axial end of the pipe to the ambient environment and applying pressurized air (or the like) at the other second axial end in order to flush the liquid out of the first open axial end.

During retrieval of a sprinkler strip from a field, axial forces may be applied on regions of the irrigation pipe and the sprinkler stand. Such forces may rise in cases where resistance to the sliding of the sprinkler stand in the retrieval direction occurs, e.g., due to engagement of such a stand with an obstacle in its retrieval path.

Since the coupling between the pipe and the sprinkler stand may mainly occur via the attachment of the sprinkler or its riser with an outlet of the pipe, regions of the sprinkler stand associated with this coupling (such as the clamp member) may be suitably designed to resist such forces.

As a result, to adapt a sprinkler stand to its intended use of being slidably retrieved form a field, at least some of the following structural considerations may be embodied therein.

As seen in FIG. 4, the base may be designed with cavities 18 at its opposing lateral sides for receiving/housing the first and second mating regions of the clamp members, and each cavity 18 may be formed with a pair of walls 181 that bound the cavity at it longitudinal sides. The cavities and their walls 18, 181 are structurally arranged to provide axial support for the clamp member 122 of the sprinkler stand at its first and second mating regions 1221, 1222 in order to counter the axial forces applied on the clamp member during retrieval.

The axial forces applied during retrieval of a sprinkler strip may give rise also to moment forces that are applied upon the outlets of the pipe. Such moment forces may be formed due to interaction of the sprinkler and its riser on the one hand with the clamp member and on the other hand with the outlet of the pipe.

In order to limit the formation of such moment forces, a distance between the outlet of the pipe and the lower side of the clamp member may preferably be limited as much as possible, while still providing adequate spacing for the proper operation of the sprinkler stand during its use in providing irrigation.

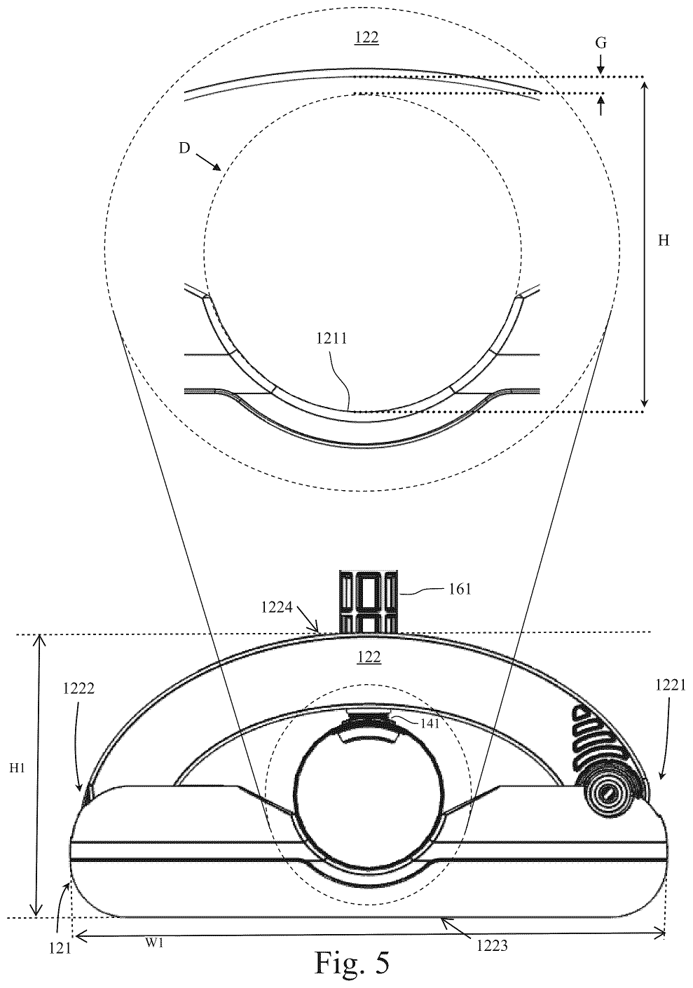

The following structural considerations may thus be embodied in a sprinkler stand to meet this target. As seen in FIG. 5, the clamp member 122 may have a generally low profile above the base resulting at a minimal height H that is formed above the base at the clamp member's center where passage 123 is located, when the clamp member is in the deployed position.

The low profile of the clamp member may be characterized in the clamp member following a path of varying curvature on its route between its first and second mating regions 1221, 1222—starting at a relative high curvature, e.g., at mating region 1221, and then lowering the curvature (i.e., a reduced curvature) towards its center adjacent passage 123, and then increasing the curvature towards mating region 1222.

Such varying curvature may also be defined by the clamp member following a general elliptical path between its first and second mating regions 1221, 1222, with the major axis of such an imaginary ellipse being defined by an imaginary straight line passing through centers of the first and second mating regions 1221, 1222.

The height H of the clamp member as seen is defined above the base's depression 1221, which is suited to support pipes of varying diameter. In certain embodiments the largest diameter pipe that can be supported by the depression may be of a pipe having a diameter generally similar to the diameter D of the cylindrical shape of the depression. Therefore, a lower limit of H may be roughly equal to about D.

In certain cases, a gap G may be maintained above D to limit e.g., the likelihood that a collapsible pipe having an inflated diameter D may engage and press upwards against the clamp member. Therefore, an upper limit of H may be roughly equal to D+G.

Gap G may be set to be as small as possible, e.g., up to about 20% or preferably up to about 10% of D in order to limit as much as possible the height H of the clamp member above the pipe's outlet and hence the moment forces that may be applied at the outlet during retrieval of a sprinkler strip from a field. As such, one criterion for a clamp member to be considered “low profile” is that it satisfy the relationship D<H<1.2*D.

Returning to FIG. 5, the base 121 has a base width W1 measured along its lateral extension which is orthogonal to the longitudinal extension. With the clamp member 122 in the deployed position of FIG. 5, the sprinkler stand 12 has a stand height H1 measured from the base's lower surface 1223 (which may rest on the ground surface) to the top 1224 of the clamp member 122. The overall sprinkler stand 12 may be considered to have a low profile when the ratio H1/W1<1.0; i.e., the stand height H1 is less than the base width W1. More preferably H1/W1<0.7. Having a low profile stand may allow an irrigation pipe to be wound on a reel, with spaced apart sprinkle er stands attached thereto.

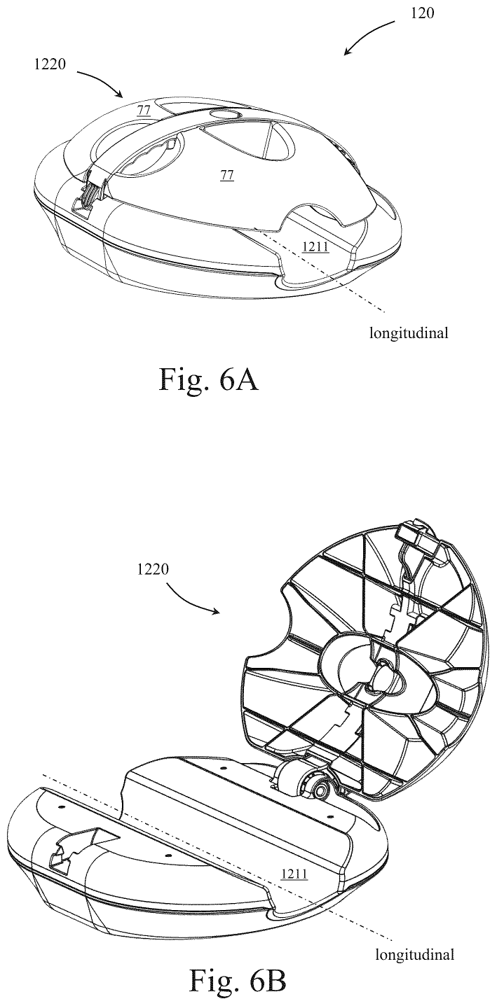

Attention is drawn to FIGS. 6A and 6B that schematically show another embodiment of a sprinkler stand 120 in respective deployed and non-deployed states. Sprinkler stand 120 is generally similar to sprinkler stand 12 seen in FIGS. 1 to 5, and may be defined as mainly differing from it in having a clamp member 1220 that generally has a cover-like formation, which substantially overlies an entire length of the depression 1211 in a direction along the longitudinal extension of the base.

Such coverage of the depression 1211 by clamp member 1220 may be accomplished in this example by adding attachable wing members 77 to opposing longitudinal sides of an arm-like clamp member generally similar to the clamp member 122 in sprinkler stand 12.

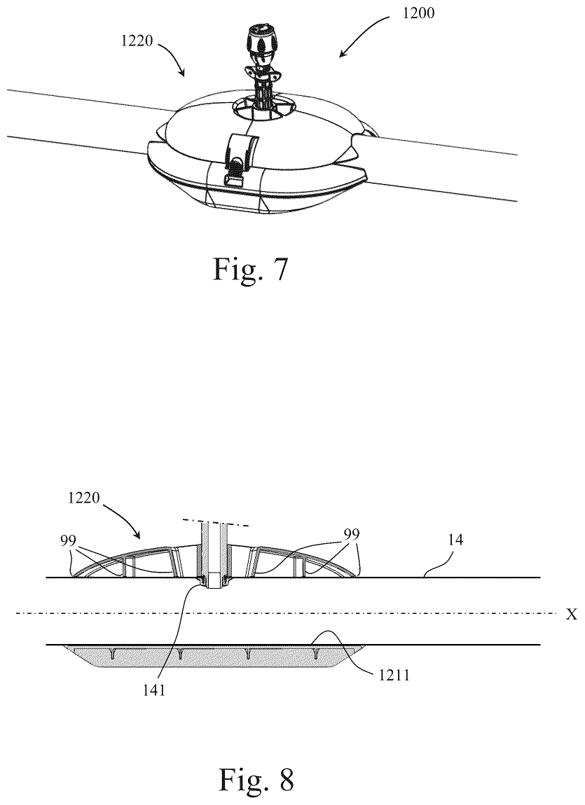

Attention is additionally drawn to FIG. 7 schematically showing another embodiment of a sprinkler stand 1200 generally similar to that in FIGS. 6A and 6B, however in this example embodying an integrally formed clamp member 1220 having a cover-like formation.

Attention is additionally drawn to FIG. 8 schematically showing a cross sectional view of a sprinkler stand (such as in FIGS. 6 and 7) having a clamp member 1220 that substantially overlies an entire length of the depression 1211 in a direction along the longitudinal extension of the base.

As seen, the clamp member 1220 may be designed to adjacently follow the outer contour of the irrigation pipe also in regions adjacent to the longitudinal sides of the depression 1211. In an example of the pipe being a collapsible pipe, the clamp member 1220 may be designed to adjacently follow an outer contour of the pipe generally in its inflated state.

In this example, following the outer contour of the irrigation pipe may be accomplished by providing abutment rims 99 on the inner side of the clamp member 1220 that faces the pipe, with at least one of the abutment rims 99 being located substantially above each longitudinal end of the depression 1211.

Provision of such a clamp member 1220 that is designed to adjacently follow an outer contour of the irrigation pipe from above, may assist in maintaining the irrigation pipe closely adjacent to depression 1211 as it extends through the sprinkler stand.

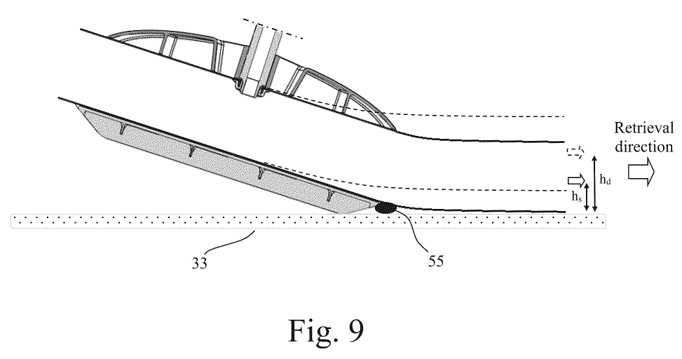

Attention is drawn to FIG. 9 schematically showing a possible tilted state that sprinkler stands in accordance with various embodiments of the present invention may assume during retrieval from a field possibly when engaging an obstacle 55 in their retrieval route. Such an obstacle may be a physical object in the retrieval route or simply friction that the stand may encounter during retrieval.

The irrigation pipe marked by the “solid” lines illustrates an extension of a pipe through a sprinkler stand, which includes a clamp member 1220 (such as in FIGS. 6 to 8) that substantially overlies an entire length of the depression 1211 in a direction along the longitudinal extension of the base.

The irrigation pipe marked by the “dashed” lines illustrates an extension of a pipe through a sprinkler stand that includes a clamp member 122 (such as in FIGS. 1 to 5) having an arm-like formation that substantially extends between the first and second mating regions 1221, 1222 over the depression, and hence overlies only a relative central section of the depression 1211.

As seen, in an event that the sprinkler stand is tilted, the “dashed” lined irrigation pipe, which is not constrained to extend along substantially the full extension of the depression, may be urged at its central axis outside of the stand (in the direction of retrieval) to extend a distance ‘hd’ above a ground face 33. On the other hand, the “solid” lined irrigation pipe, which is constrained to extend along substantially the full extension of the depression—may be urged at its central axis outside of the stand (in the direction of retrieval) to extend a distance ‘hs’ above the ground face 33, which is smaller than ‘hd’.

As a result, potential moment forces that may act to overturn a retrieved sprinkler stand, may be eliminated or substantially reduced in a retrieved sprinkler stand including a clamp member 1220 (such as in FIGS. 6 to 8) that has a cover-like formation.

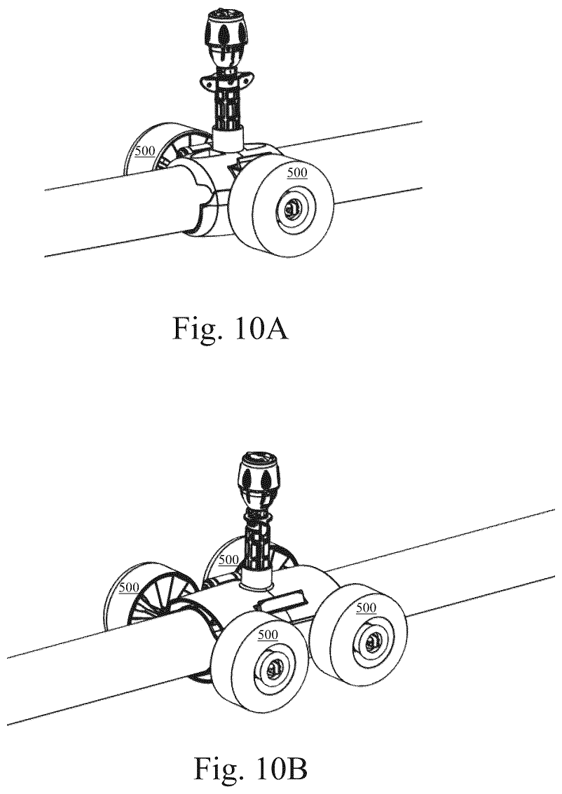

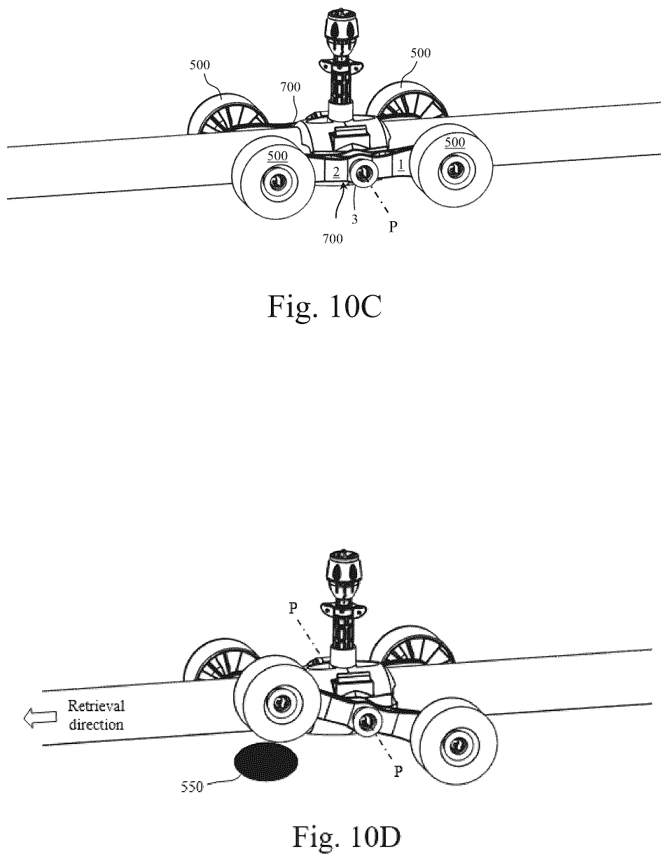

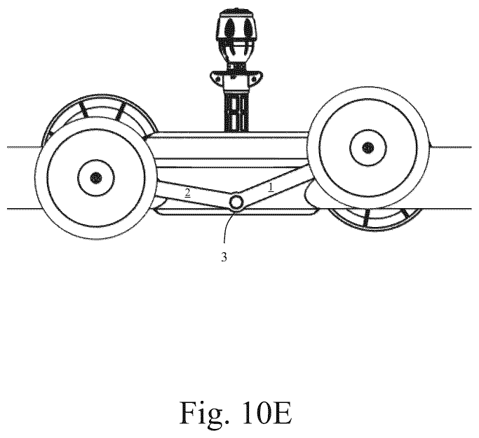

In an aspect of the present invention, retrieving an irrigation strip from a field by using the pipe to pull and retrieve the sprinkler stands—may be accomplished by providing wheeled sprinkler stands. That is to say that as opposed to the previous embodiments seen in FIGS. 1 to 9 where the sprinkler stands are retrieved by sliding them upon the ground face, in FIGS. 10A to 10E the sprinkler stands are retrievable by assistance of wheels that reduce friction between the sprinkler stands and the ground surface they roll upon.

The wheels in these shown examples may be rotatably coupled to sprinkler stands in accordance with any one of the previously disclosed embodiments. Nevertheless, in a broad aspect the wheels may also be coupled to sprinkler stands not necessarily only in accordance with the previously disclosed embodiments, but also having other formations.

In FIG. 10A, two wheels 500 are shown located at opposing lateral sides of the sprinkler stand. One of the wheels may be attached to the sprinkler stand adjacent to its first mating region 1221 and the other wheel may be attached to the sprinkler stand adjacent to its second mating region 1222.

In FIG. 10B, two wheels 500 are shown located at each opposing lateral side of the sprinkler stand, amounting to a four wheeled sprinkler stand.

FIGS. 10C and 10D, show a further example of a four wheeled sprinkler stand, however in this example each pair of wheels at a given lateral side of the sprinkler stand is associated with a beam 700 by coupling one of the wheels to adjacent one end of the beam and the other wheel to adjacent the other opposing end of the beam.

Each beam in turn may be pivotally coupled at its center to a respective one of the lateral sides of the sprinkler stand. The beam includes first 1 and second 2 sections, which in this example generally extend one in relation to the other along a straight line. A first one of the beams may be pivotally coupled to the sprinkler stand at a first one of its lateral sides, thus enabling the beam 700 to pivot at its center about an axis P that extends laterally away from said lateral side. A second one of the beams (on the far side of the figure) may be similarly pivotally coupled to the sprinkler stand however at its opposing lateral side, thus enabling the beam 700 to pivot at its center 3 about an axis P that extends laterally away from said opposing lateral side.

Provision of such a formation may assist in balancing such a four wheeled sprinkler stand as it traverses obstacles that may exist in its retrieval path. As a wheel of the sprinkler stand encounters an obstacle 550, the absorbed upward directed force exerted by the obstacle may urge the impacted wheel to move upwards and the beam to pivot with respect to the irrigation stand about axis P.

As a result, tilting of the irrigation stand about axis P may be substantially avoided or substantially reduced resulting in a more balanced movement along the ground face of the field. Alternatively, or in addition, sideways tilting of the sprinkler stand generally about the pipe's longitudinal axis may be reduced-since the sprinkler stand at the location where it pivotally couples to the beam rises to a smaller extent than the wheel that engages the obstacle.

In FIG. 10E a four wheeled sprinkler stand can be seen where the first 1 and second 2 sections of each one of its beams 700 are tilted relative to each other resulting in a lowering of its center 3 towards the ground face. Such lowering of a beam's center 3 towards the ground face may assist in certain cases in stabling the sprinkler stand as it is retrieved from a field.

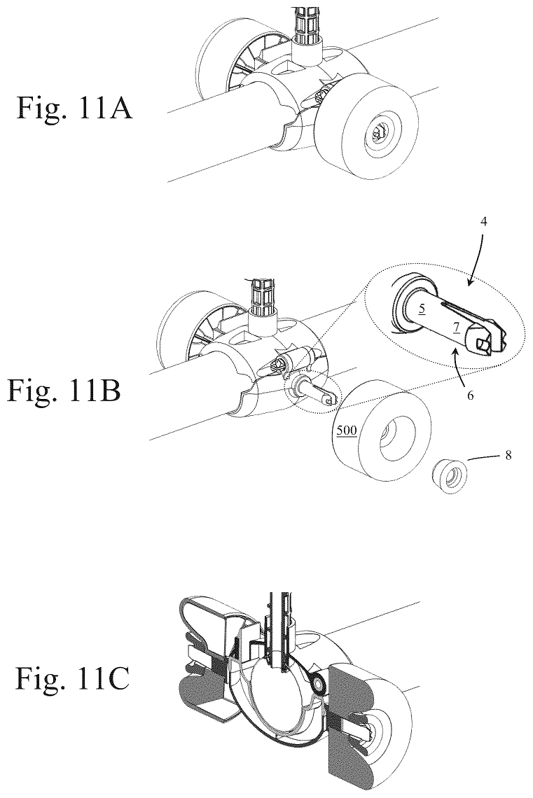

Attention is drawn to FIGS. 11A to 11C. In at least certain embodiments the wheels may be attachable to pivot shafts 4 of the sprinkler stand. As seen in FIG. 11B, the pivot shafts may include base 5 and tip 6 sections. The tip section 6 may be separated/cut into to resilient legs 7 and the base section 5 remains un-cut.

The sprinkler stand in these embodiments includes spacers 8 and attaching a wheel 500 to its pivot shaft 4 may be accomplished by first snapping the wheel over the resilient legs 7 of its pivot shaft and completing the attachment of the wheel by snapping a spacer 8 over the resilient legs 7 of the pivot shaft in order to maintain the wheel upon the base section 5 of the pivot shaft that is more suitable to support the revolving of the wheel during use of the sprinkler stand.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

What is claimed is:

1. A sprinkler irrigation stand comprising:
a base having an upper surface and a lower surface which is configured to rest on a ground surface, the upper surface having a depression that extends along a longitudinal extension of the base, the lower surface having a base width (W1) measured in a lateral extension of the base which is orthogonal to the longitudinal extension; and
a clamp coupled to a first lateral side of the base at a first mating region, the clamp comprising a clamp passage configured to slidably receive a lower portion of a sprinkler;
wherein:
in the non-deployed state, the clamp is not attached to an opposing second lateral side of the base;
in the deployed state, the clamp is attached to the opposing second lateral side of the base at a second mating region and the clamp passage directly overlies the depression; and
the stand has a stand height (H1) measured from the lower surface of the base to a top of the clamp; when in the deployed state.

2. The sprinkler irrigation stand of claim 1, wherein at least in an imaginary plane orthogonal to the base's longitudinal extension and passing through the first and second mating regions,
the clamp in its deployed state has a low profile above the base while bridging between the first and second lateral sides of base.

3. The sprinkler irrigation stand of claim 2, wherein the low profile is characterized by the clamp following a generally elliptical path between the first and second mating regions with a major axis of such an imaginary ellipse being defined by an imaginary straight line passing through the first and second mating regions.

4. The sprinkler irrigation stand of claim 2, wherein the low profile is characterized by the clamp following a path of varying curvature on its route between its first and second mating regions, starting at a first curvature at the first mating region, a second curvature over the depression, and a third curvature proximate the second mating region, the first and third curvatures being greater than the second curvature.

5. The sprinkler irrigation stand of claim 1, wherein the depression comprises a generally cylindrical imaginary surface that has an axis extending in the longitudinal direction.

6. The sprinkler irrigation stand of claim 5, wherein at least in an imaginary plane orthogonal to the base's longitudinal extension and passing through the first and second mating regions:
a diameter of the cylindrical imaginary surface (D) and a height (H) of the clamp above a lowest portion of the depression satisfies the relationship D≤H≤D+G, where G is defined as a gap being equal to about 20% of D.

7. The sprinkler irrigation stand of claim 1, wherein:
the first and second mating regions are located in cavities formed in the base; and
each cavity comprises opposing walls that are located on opposing longitudinal sides of an end portion of the clamp.

8. The sprinkler irrigation stand of claim 1, wherein the clamp overlies an entire length of the depression in a direction along the longitudinal extension of the base.

9. The sprinkler irrigation stand of claim 1, further comprising at least two wheels, each wheel being located at a respective opposing lateral side of the irrigation stand.

10. The sprinkler irrigation stand of claim 1, wherein the clamp is pivotally coupled to the first lateral side of the base.

11. The sprinkler irrigation stand of claim 1, wherein the stand height (H1) is less than the base width (W1).

12. The sprinkler irrigation stand of claim 11, wherein the stand height (H1) is less than 0.7 times the base width (W1).

13. A sprinkler strip assembly comprising:
a plurality of spaced apart sprinkler stands in accordance with claim 1;
an irrigation pipe having spaced apart pipe sections thereof resting on the depressions of said plurality of spaced apart sprinkler stands, each pipe section having a pipe outlet; and
a sprinkler coupled to each pipe outlet at a corresponding sprinkler stand;
wherein:
the clamp of each sprinkler stand is in the deployed state with the sprinkler protruding through the clamp passage of said clamp.

14. A method of retrieving a plurality of spaced apart sprinkler stands according to claim 1 from a field, the sprinkler stands being attached to one another by a common irrigation pipe having pipe sections clamped by each of the sprinkler stands, each sprinkler stand having sprinkler passing through the clamp passage of that sprinkler stand, the method comprising:
applying a pulling force to an end of the irrigation pipe, thereby urging the irrigation pipe to move in a retrieval direction together with the sprinkler stands which remain attached to the irrigation pipe.

15. The method of claim 14, wherein:
the irrigation pipe has a plurality of spaced apart pipe outlets, each pipe outlet located beneath the clamp of a corresponding sprinkler stand, when the clamp is in the deployed position;
each sprinkler is coupled to one of said plurality of pipe outlets; and
each sprinkler stand remains attached to the irrigation pipe during the retrieval via the coupling between said each sprinkler and said one of said plurality of pipe outlets.

16. The method of claim 15, wherein the irrigation pipe is a collapsible pipe having prefabricated, spaced apart pipe outlets.

17. The method of claim 16, wherein the pulling force is applied by winding the end of the irrigation pipe on a reel.

18. The method of claim 17, wherein prior to applying the pulling force, the irrigation pipe is flushed to remove excess liquid from the pipe.

19. The method of claim 18, comprising: opening a first end of the pipe to the ambient environment and applying air pressure to a second end of the pipe to remove excess liquid out of the first end.

20. The method according to claim 15, wherein each sprinkler stand comprises wheels for assisting retrieval from the field, by reducing friction between the sprinkler stand and the ground surface it rolls upon.

21. A sprinkler irrigation stand comprising:
a base having an upper surface and a lower surface which is configured to rest on a ground surface, the upper surface having a depression that extends along a longitudinal extension of the base, the lower surface having a base width (W1) measured in a lateral extension of the base which is orthogonal to the longitudinal extension; and
a clamp coupled to a first lateral side of the base at a first mating region, the clamp having a non-deployed state and a deployed state;
wherein:
in the non-deployed state, the clamp is not attached to an opposing second lateral side of the base, and
in the deployed state, the clamp is attached to the opposing second lateral side of the base at a second mating region, the clamp overlying an entire length of the depression in a direction along the longitudinal extension of the base.

22. A sprinkler irrigation stand comprising:
a base having an upper surface and a lower surface which is configured to rest on a ground surface, the upper surface having a depression that extends along a longitudinal extension of the base, the lower surface having a base width (W1) measured in a lateral extension of the base which is orthogonal to the longitudinal extension;
a clamp coupled to the base; and
at least two wheels, the at least wheels being located on opposite lateral sides of the base, the wheels configured to reduce friction between the sprinkler stand and a ground surface on which the sprinkler stand is positioned, during retrieval of an irrigation pipe supported by the sprinkler irrigation stand.

23. The sprinkler irrigation stand of claim 22, comprising a pair of wheels located on each lateral side of the base.

24. The sprinkler irrigation stand of claim 23, further comprising:
a pair of beams, each beam pivotally connected at a beam center thereof to one of the lateral sides of the base, each beam having opposing first and second ends;
wherein:
the pair of wheels located on each lateral side of the base are mounted at the opposing first and second ends of a corresponding beam.

25. The sprinkler irrigation stand of claim 24, wherein each beam comprises a first section extending from the beam center to the first end and a second section extending from the beam center to the second end, the first and second sections being tilted relative to one such that the beam center is lower than both the first end and the second end, when the sprinkler irrigation stand is placed on a ground surface.
